(19) United States
(12) Patent Application Publication
(10) Pub. No.: US 2014/0261848 A1
(43) Pub. Date: Sep. 18, 2014

(54) Integral Valve Assembly

(71) Applicant: TYL, Inc., Fort Worth, TX (US)

(72) Inventor: Tripp RODEN, Keller, TX (US)

(73) Assignee: TYL, Inc., Fort Worth, TX (US)

(21) Appl. No.: 14/213,297

(22) Filed: Mar. 14, 2014

Related U.S. Application Data
(60) Provisional application No. 61/794,996, filed on Mar. 15, 2013.

(51) Int. Cl. F16L 9/02; F16K 1/14

(52) U.S. Cl. CPC F16L 9/02; F16K 1/14
USPC 138/177; 251/315.01

(57) ABSTRACT

An integral valve assembly includes a major span of piping having a first end and a second end opposite the first end, a first minor span of piping extending perpendicularly from the major span between the first end and the second end of the major span, and a second minor span of piping extending obliquely from the major span between the first minor span and the second end of the major span, wherein the major span, the first minor span, and the second minor span are together monolithic, wherein the major span, the first minor span, and the second minor span are stainless steel.

### CROSS-REFERENCE TO RELATED APPLICATION

This application claims the benefit of U.S. Provisional Application No. 61/794,996, filed Mar. 15, 2013, titled “Integral Valve Assembly,” which is incorporated herein in its entirety by reference thereto.

### BACKGROUND

1. Field

Embodiments of the present invention relate to a pipe fitting and/or valve assembly. In some embodiments, the valve assembly is integrally formed of stainless steel and has a major span and multiple minor spans spaced apart and extending from the major span. In some embodiments, the valve assembly includes a ball valve incorporated therein.

2. Background

A pipe fitting assembly may be incorporated into a pipe assembly to direct the flow of a fluid through the pipe assembly. Fluid within the fitting assembly may apply substantial pressure on the fitting assembly. In some instances, for example, a fitting assembly having multiple spaced-apart inlet/outlet ports may be used to contain and direct the flow of highly pressurized liquid or as (e.g., from a chemical tank). The ports may couple to other elements including elements of an overall pipe assembly into which the fitting assembly is incorporated.

A valve may be incorporated into the fitting assembly to further control fluid flow, In a fully open position a valve may allow maximum fluid flow rate, in a closed position the valve may prevent fluid flow rate, or in any of a variety of intermediate (or partially-open) positions the valve may allow some level of fluid flow rate between maximum fluid. flow and no fluid flow. To effectively manage high pressures (i.e., to minimize the chances of failure), valve assemblies may be formed of metal, for example, of stainless steel. Stainless steel such as grade 316 stainless steel (e.g., CF8M stainless steel) may provide further benefits such as corrosion resistance.

In some cases, for example, a fitting assembly FA (see FIG. 2) may include a variety of separate fittings fit together. Forming a fitting assembly from a variety of separate fittings has conventionally been considered beneficial in order to promote configurability in the fitting assembly through selection of the separate fittings to form the fitting assembly. For example, conventional fitting assembly FA may include a valve fitting VF, a T-fitting TF, a Y-fitting YF, and a reducer plug RP. As shown in FIG. 2, valve fitting VF, T-fitting TF, and Y-fitting YF may be threaded together by nipples NN, and T-fitting IF may include a nipple NN for connection to other parts of a larger pipe assembly. Fitting assembly FA may have multiple spaced-apart ports, including end ports EP positioned at opposite ends of fitting assembly FA, and side ports SP spaced apart between end ports EP.

Because such fitting assemblies are intended to contain and direct pressurized fluid flow, they should not leak (i.e., should not allow fluid to migrate from within the fitting assembly to without the fitting assembly, except through normal internal flow channels). This is especially important where the fluid contained within the fitting assembly may be harmful to the external environment (e.g., harmful chemicals from a chemical tank), including life-forms living and working in the external environment. For example, flow of hazardous chemicals may be contained and directed by a pipe fitting assembly on an oil and/or gas extraction or processing site. It is important to contain and direct this chemical flow as intended, without leaks, to avoid introducing such chemicals into the environment, causing potentially damaging effects. Further, instances of such leaks can result in the imposition of undesirable fines and other action by regulatory agencies.

To guard against leaks, conventionally actors in industries seeking to minimize leakage (including the oil and gas industry, and other chemical storage and transport industries) have attempted to provide tight interconnection of the separate pieces forming such a fitting assembly. To this end, threads were carefully machined to high tolerances, and connection media such as, for example, Teflon® tape, was used between mating threads to reduce the possibility of leakage at connection points. Still leaks occurred, and conventional actors in industries seeking to minimize leakage sought to improve leak reduction by welding the separate fittings of fitting assemblies together. Seeking a strong weld, and seeing no better alternative to protect against leaks, conventional actors even resorted to underwater welding the separate fittings of fitting assemblies together. Throughout industries seeking to minimize leakage (including the oil and gas industry, and other chemical storage and transport industries^{.}), underwater welding of pipe fitting assemblies (e.g., for use in connection with chemical tanks) has become the standard way to form fitting assemblies.

Even underwater-welded fitting assemblies can leak, however. High pressure and/or defects in the weld material or technique may cause a weld to fail (i.e., leak). Welded assemblies, further, involve a great deal of processing including assembly and the welding procedure itself, and are prone to errors in construction. For example, in addition to defects in the welds themselves, fittings of the fitting assembly may be misaligned, such that the fitting assembly does not fit as intended within the overall pipe assembly into which it will be incorporated, or puts undue stress on the pipe assembly due to its misalignment.

Moreover, in any conventional fitting assembly, the multiple separate fittings fitted together result in interruptions in the inner surface of the fitting assembly, such that the inner surface is not smooth. This can promote undesirable turbulent fluid flow, and can cause undesirable localized increases in pressure at the fitting interfaces. Further, the multiple separate fittings require a great deal of material (e.g., stainless steel) in order to establish interfaces (e.g., threaded connections) between the fittings. This additional material is costly and adds substantial weight to a fitting assembly, which must be supported within the overall pipe assembly.

What is needed is a valve assembly suitable for use in industries seeking to minimize leakage (including the oil and gas industry, and other chemical storage and transport industries) that can withstand high internal pressure without leaking and that is easily incorporated into a pipe assembly with minimal assembly and processing. At least some of the embodiments of the present invention satisfy the above needs and provide further related advantages as will be made apparent by the description that follows.

### BRIEF SUMMARY

Some embodiments of the present invention provide an integral valve assembly, including a major span of piping having a first end and a second end opposite the first end, a first minor span of piping extending perpendicularly from the major span between the first end and the second end of the major span, and a second minor span of piping extending obliquely from the major span between the first minor span and the second end of the major span, wherein the major span, the first minor span, and the second minor span are together monolithic, wherein the major span, the first minor span, and the second minor span are stainless steel.

Additional features of embodiments of the invention will be set forth in the description that follows, and in part will be apparent from the description, or may be learned by practice of the invention. Both the foregoing general description and the following detailed description are exemplary and explanatory and are intended to provide further explanation of the invention as claimed.

### BRIEF DESCRIPTION OF THE FIGURES

The accompanying figures, which are incorporated herein, form part of the specification and illustrate embodiments of the present invention. Together with the description, the figures further serve to explain the principles of and to enable a person skilled in the relevant arts to make and use the invention.

FIG. 1 illustrates a perspective view of an integral valve assembly, according to an embodiment presented herein.

FIG. 2 illustrates a top view of a conventional pipe fitting assembly.

FIG. 3 illustrates a top view of the valve assembly of FIG. 1.

FIG. 4A illustrates a front view of the valve assembly of FIG. 1.

FIG. 4B illustrates a partial cross-sectional front view of the valve assembly of FIG. 1.

FIG. 5 illustrates a bottom view of the valve assembly of FIG. 1.

FIG. 6 illustrates a rear view of the valve assembly of FIG. 1.

FIG. 7 illustrates a left side view of the valve assembly of FIG. 1.

FIG. 8 illustrates a right side view of the valve assembly of FIG. 1.

FIG. 9 illustrates an exploded front view of the valve assembly of FIG. 1.

FIG. 10 illustrates an exploded front view of the valve assembly of FIG. 1 in use.

### DETAILED DESCRIPTION

Embodiments of the present invention will now be described in detail with reference to embodiments thereof as illustrated in the accompanying drawings, in which like reference numerals are used to indicate identical or functionally similar elements. References to “one embodiment”, “an embodiment”, “some embodiments”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present invention. Other suitable modifications and adaptations of the variety of conditions and parameters normally encountered in the field, and which would be apparent to those skilled in the art, are within the spirit and scope of the invention.

Leaks in pipe fitting assemblies as described above tend to occur at the interfaces between fittings of the fitting assembly. For example, as shown in FIG. 2, leaks in fitting assembly FA may tend to occur at the interfaces between a valve fitting VF and a first nipple NN, first nipple NN and a T-fitting TF, T-fitting TF and a second nipple NN, second nipple NN and a Y-fitting YF, and Y-fitting and a reducer plug RP. The multitude of interfaces provides a multitude of potential weaknesses due to defects or inconsistencies in weld material and quality, or simply lower strength relative to the continuous portions of the separate fittings forming the fitting assembly. The multitude of interfaces also may interfere with laminar fluid flow through the fitting assembly.

An integral valve assembly 100 according to embodiments of the present invention takes the place of a fitting assembly and reduces or eliminates interfaces between parts. In some embodiments (for example, the embodiment shown in FIGS. 1 and 3-10, integral valve assembly 100 includes a major span 200 of piping extending straight about a central axis 210 and having a first end 220 and a second end 230. Between major span first end 220 and major span second end 230 integral valve assembly 100 may include a first minor span 300 of piping extending straight about a central axis 310 away from major span 220. First minor span 300 is in fluid communication with major span 200. Also between major span first end 220 and major span second end 230 integral valve assembly 100 may include a second minor span 400 of piping extending straight about a central axis 410 away from major span 220. Second minor span 400 is in fluid communication with major span 200.

Major span 200, first minor span 300, and second minor span 400 are integral and formed into a single fitting 100. In other words, major span 200, first minor span 300, and second minor span 400 of integral valve assembly 100 are continuous and monolithic (see FIGS. 1, 3, 4A and 4B). In some embodiments, this is effected by casting major span 200, first minor span 300, and second minor span 400 together as a single part. The integral nature of integral valve assembly 100 goes against common practice and belief that fitting assemblies such as those described above should be used for their configurability. However, an unexpected benefit of forming integral valve assembly 100 as an integral piece is the elimination of weaknesses and potential leak points by eliminating interfaces between separate fittings, seen, for example, in the partial cross-sectional view of FIG. 4B, taken through the major span central axis 210 in the direction of arrows 4B, 4B′ of FIG. 3.

Moreover, in some embodiments integral valve assembly 100 is formed of stainless steel, in order to have sufficient strength for industrial use, including use in industries seeking to minimize leakage of fluid under substantial pressure (including the oil and gas industry, and other chemical storage and transport industries). For example, in some embodiments integral valve assembly 100 (including major span 200, first minor span 300, and second minor span 400) may be formed of grade 316 stainless steel, may be corrosion-resistant, and/or may be formed of CF8M stainless steel. Further, in some embodiments integral valve assembly 100 is sized to a ¾-inch standard, in order to be readily usable industrially, where a ¾-inch standard is common. The present invention is not limited to a ¾-inch standard, however. In some embodiments, integral valve assembly 100 may be formed at a larger or smaller standard, or in a nonstandard size. In other embodiments, other suitable materials including, but not limited to other metals (e.g., other types of stainless steel, iron, aluminum, copper), plastic, polyvinyl chloride (PVC), rubber, and ceramic may be used.

In some embodiments, to further decrease interface interference, major span 200, first minor span 300, and second minor span 400 are formed seamlessly (e.g., by integral casting). In some embodiments, depending on application, major span 200, first minor span 300, and second minor span 400 may be formed with seams (e.g., formed of seamed. stainless steel).

In some embodiments, first minor span 300 and second minor span 400 may be positioned and oriented with respect to major span 200 in order to be suitable for some uses in connection with, for example, chemical or other fluid tanks (e.g., for oil or gas extraction, weed control, or other chemical or other fluid applications). In some embodiments, both first minor span 300 and second minor span 400 may be positioned between major span first end 220 and major span second end 230 (see FIGS. 3 and 4A). First minor span 300 may be positioned between major span first end 220 and second minor span 400. Second minor span 400 may be positioned between major span second end 230 and first minor span 300. Further, major span 200, first minor span 300, and second minor span 400 may be in fluid communication (i.e., internal passages of major span 200, first minor span. 300, and second minor span 400 may intersect).

In some embodiments, first minor span central axis 310 may be oriented perpendicularly with respect to major span central axis 210 (see FIG. 3), and second minor span central axis 410 may be oriented obliquely with respect to major span central axis 210 (see FIG. 4A). First minor span 300 and second minor span 400 may not extend in the same plane. For example, in some embodiments, first minor span central axis 310 and second minor span central axis 410 may define an angle of 90 degrees therebetween, with respect to major span central axis 210 (see FIGS. 7 and 8).

In some embodiments, integral valve assembly 100 includes a valve 500, which may be, for example, a ball valve, a gate valve, a globe valve, a pinch valve, a diaphragm valve, a needle valve, a plug valve, a butterfly valve, a check valve, a pressure-relief valve, or a control valve. In some embodiments, including that shown in the figures, valve 500 may be positioned within major span 200 (see FIG. 8). Alternatively (or additionally in the case multiple valves 500 are used), valve 500 may be positioned within first minor span 300 or second minor span 400. Valve 500 may be configured to regulate fluid flow (e.g., from a chemical tank) through the point of integral valve assembly 100 at which valve 500 is positioned. In some embodiments, valve 500 is positioned within major span 200 between major span first end 220 and first minor span 300.

In some embodiments, integral valve assembly 100 contains a filter 600. Filter 600 may be disposed within, for example, second minor span 400, as shown in the exploded view of FIG. 9. Filter 600 may be removable (e.g., for cleaning). Filter 600 may collect contaminants and other particulate matter that may be present within fluid flowing through integral valve assembly 100. Filter 600 may be retained within second minor span by a removable filter cap 610 that may removably seal second minor span 400. For example, fitter cap 610 may detachably couple to an end of second minor span by, for example, a threaded connection (e.g., via second minor span end threads 422).

As noted above, integral valve assembly 100 may be used in a larger pipe assembly. To facilitate such use, ends of integral valve assembly 100 may include attachment features to allow coupling to other elements. In some embodiments, major span first end 220 includes major span first end threads 222, and major span second end 230 includes major span second end threads 232. Similarly, first minor span end 320 may include first minor span end threads 322, and second minor span end 420 may include second minor span end threads 422. Such threads can be of any suitable type, and may be tailored to mesh with threads of an intended element to be attached. For example, threads can be standard pipe thread configuration, standard hose thread configuration, other standard configuration, or a nonstandard configuration. Any of major span first end threads 222, major span second end threads 232, first minor span end threads 322, and second minor span end threads 422 threads can be either male (external) or female (internal). For example, major span first end threads 222 may be female (see FIGS. 1 and 8), major span second end. threads 232 may be female (see FIG. 7), first minor span end threads 322 may be male (see FIGS. 1 and 3), and second minor span end threads 422 may be female (see FIG. 9).

In some embodiments ends of integral valve assembly may be sized to allow coupling to other elements. In some embodiments ends of integral valve assembly 100 may include reducers or enlargers to change their diameter to facilitate coupling to other elements. For example, major span first end 220 may include or be configured to couple to a first reducer 224 (see FIG. 10) that is sized and threaded to couple to a gauge (e.g., a pressure or flow gauge). Also for example, major span second end 230 may include or be configured to couple to a second reducer 234 (see FIG. 3) that is sized and threaded to couple to a hose 800 (e.g., a stainless steel or rubber hose), which can be used, for example to further transfer the fluid contained therein, or to expel the fluid to a target location, such as a lawn being watered or chemically treated (e.g., via hose 800).

In use, fluid may flow in any direction through integral valve assembly 100. In some embodiments, fluid may flow in the directions indicated by the arrows of FIGS. 3 and 4A. in this way, fluid may flow into integral valve assembly 100 through first minor span 300 (e.g., from a connected chemical tank). Fluid may then flow in both directions of major span 200. Fluid flowing in the direction of major span first end 220 may flow through valve 500 (in the event valve 500 is not closed) and out of integral valve assembly 100 through major span first end 220 (e.g., to hose 800 connected thereto, see FIG. 10). Fluid flowing in the direction of major span second end 230 may flow into second minor span 400, allowing filter 600 contained therein to collect impurities and other particulates carried by the flow (see FIG. 9). Since filter cap 610 may seal second minor span end 420, fluid may not flow through and out of second minor span 400, and integral valve assembly 100 may be oriented such that second minor span 400 extends downward and obliquely away from major span 200 in the direction of fluid flow, to promote collection of impurities and other particulates therein due to fluid flow and gravitational forces. Fluid flowing in the direction of major span second end 230 may also flow through major span second end 230 to gauge 700, such that gauge 700 can assess one or more flow characteristics such as, for example, pressure, flow rate, temperature, specific gravity, density, and chemical element concentration (see FIG. 10).

The foregoing description of the specific embodiments of the integral valve assembly described with reference to the figures will so fully reveal the general nature of the invention that others can, by applying knowledge within the skill of the art, readily modify and/or adapt for various applications such specific embodiments, without undue experimentation, without departing from the general concept of the present invention.

While various embodiments of the present invention have been described above, they have been presented by way of example only, and not limitation. It should be apparent that adaptations and modifications are intended to be within the meaning and range of equivalents of the disclosed embodiments, based on the teaching and guidance presented herein. For example, a integral valve assembly according to the invention may be used in applications other than directing chemical flow and may be formed in sizes and configurations not explicitly described herein. For example, in some exemplary embodiments, integral valve assembly 100 according to the invention may include a second valve (e.g., in addition to valve 500). The additional valve may be positioned, for example, along first minor span 300 or second minor span 400.

Also for example, in some embodiments, major span first end 220 of integral valve assembly 100 may include a reducer (e.g., for connecting to a hose or other element), major span second end 230 may include an angled bend (e.g., a 90 degree bend). In such an embodiment, major span 200 may include, for example, only one minor span (e.g., first minor span 300), and the only one minor span may include a valve for controlling flow of fluid therethrough. Also in such an. embodiment, major span 200 may include, for example, a valve (e.g., valve 500) for controlling flow of fluid therethrough.

It therefore will be apparent to one skilled in the art that various Changes in form and detail can be made to the embodiments disclosed herein without departing from the spirit and scope of the present invention. The elements of the embodiments presented above are not necessarily mutually exclusive, but may be interchanged to meet various needs as would be appreciated by one of skill in the art.

It is to be understood that the phraseology or terminology used herein is for the purpose of description and not of limitation. The breadth and scope of the present invention should not be limited by any of the above-described exemplary embodiments, but should be defined only in accordance with the following claims and their equivalents.

What is claimed is:

1. An integral valve assembly, comprising:
a major span of piping having a first end and a second end opposite the first end;
a first minor span of piping extending perpendicularly from the major span between the first end and the second end of the major span; and
a second minor span of piping extending obliquely from the major span between the first minor span and the second end of the major span,
wherein the major span and the first minor span are together monolithic, and
wherein the major span, the first minor span, and the second minor span are stainless steel.

2. The valve assembly of claim 1, comprising a second minor span of piping extending obliquely from the major span between the first minor span and the second end of the major span,
wherein the second minor span is together monolithic with the major span and the first minor span.

3. The valve assembly of claim 1, comprising a valve disposed within the major span.

4. The valve assembly of claim 3, wherein the valve is disposed between the first end of the major span and the first minor span.

5. The valve assembly of claim 3, wherein the valve is a ball valve.

6. The valve assembly of claim 2, wherein the first minor span and the second minor span do not extend in the same plane.

7. The valve assembly of claim 2, wherein a central axis of the first minor span and a central axis of the second minor span define an angle of 90 degrees therebetween, with respect to a central axis of the major span.

8. The valve assembly of claim 2, wherein each of the major span, first minor span, and second minor span is straight.

9. The valve assembly of claim 1, wherein each of the major span and first minor span is seamless along its length.

10. The valve assembly of claim 2, comprising:
a filter disposed within the second minor span; and
a cap removably sealing an end of the second minor span.

11. The valve assembly of claim 1, wherein the first end of the major span, the second end of the major span and an end of the first minor span each comprise threads for connecting to other elements.

12. The valve assembly of claim 1, wherein the second end of the major span comprises a reducer configured to connect to a gauge.

13. The valve assembly of claim 1, wherein the first minor span comprises external threads at an end thereof.

14. The valve assembly of claim 1, wherein the first end of the major span comprises internal threads.

15. The valve assembly of claim 1, wherein the major span and the first minor span are 316 stainless steel.

16. The valve assembly of claim 1, wherein the major span and the first minor span are corrosion-resistant stainless steel.

17. The valve assembly of claim 1, wherein the major span and the first minor span are CF8M stainless steel.

18. The valve assembly of claim 1, Wherein the major span and the first minor span are stainless steel sized to a ¾-inch pipe standard.
